(19) United States
(12) Patent Application Publication
(10) Pub. No.: US 2004/0070111 A1
(43) Pub. Date: Apr. 15, 2004

(54) Zipper and method of making zipper composition

(76) Inventor: Chen-Chou Hsieh, Kaohsiung City (TW)

Correspondence Address: BIRCH STEWART KOLASCH & BIRCH, PO BOX 747, FALLS CHURCH, VA, 22040-0747, US

(21) Appl. No.: 10/266,569

(22) Filed: Oct. 9, 2002

(51) Int. Cl. B29D 5/00

(52) U.S. Cl. 264/252; 525/54.31

(57) ABSTRACT

A zipper and method of making zipper composition include zipper materials that consist of about 90% of starch (by weight), 8-12% of natural polymer (by weight) and about 10% of organic polymer (by weight). The zipper materials are heated and blended, and formed zipper teeth and a linking zipper tape by an integrated injection molding process to encase a layer of paper fibers therein. The zipper thus made may be reclaimed and recycled, and can enhance environmental protection and conservation.

### FIELD OF THE INVENTION

The present invention relates to a zipper and method of making zipper composition, and particularly a zipper formed by an integrated injection molding process and consists of zipper teeth and zipper fabric tapes that encase paper fibers therein to enhance the zipper strength.

### BACKGROUND OF THE INVENTION

A lot of conventional zippers now available on the market have zipper teeth made from engineering plastics by injection forming. The zipper teeth are bonded to a fabric zipper fabric tape to become an integrated member. Some other zippers have the zipper teeth made from metal by die casting, then the zipper teeth are fastened to the fabric zipper tape. The zipper teeth are protruded on the upper and lower surface of the fabric zipper tape. When in use, the plastic or metal zippers are stitched to the clothes. However, when the clothes are not longer use and to be discarded, the plastic zippers and metal zippers cannot decompose or be reclaimed. It creates environmental protection and conservation problems.

### SUMMARY OF THE INVENTION

Therefore the primary object of the invention is to resolve the aforesaid disadvantages. The invention provides a method of making zipper compositions and zippers to overcome the problems that occur to conventional zippers made from engineering plastics or metal such as difficult to decompose, not reclaimable and not environmental protection enabled.

According to the invention, the materials for making the zipper of the invention consist of:

starch 78-82% (by weight),

natural polymer (i.e. pine resin) 8-12% (by weight), and

organic polymer (i.e. polyethylene terephthalate or polycarbonate) 8-12% (by weight).

The method of making zippers based on the foregoing materials includes the following steps:

1. selecting zipper materials (starch, natural polymer and organic polymer) according to selected weight proportions;

2. heating and blending the materials until viscous;

3. forming zippers with zipper teeth having paper fibers therein and a linking zipper tape, by an integrated injection molding process.

The zipper thus made has an upper and lower protruding portion in the inner side thereof. The upper and lower protruding portion has a first flute formed in the center that is extended outwards to connect a second flute formed in the center of the zipper tape. The first flute and the second flute encase paper fibers therein.

The zippers made according to the invention have the following advantages:

1. As the zipper materials consist of 90% of starch and natural polymer, and about 10% of organic polymer (such as polyethylene terephthalate or polycarbonate), and are heated and blended, and formed by an integrated injection molding process to make the zipper teeth and zipper tape, when the zippers are not longer used and to be discarded, they are reclaimable, thus may enhance environmental protection and conservation.

2. The zipper has paper fibers encased therein during the injection molding process, thus has a greater strength.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a top view of the zipper of the invention.

FIG. 1B is a cross sectioned view, on the line 1B-1B in FIG. 1A, of the zipper of the invention.

### DESCRIPTION OF THE PREFERRED EMBODIMENTS

According to the invention, the materials for making the zipper of the invention consist of:

starch 78-82% (by weight),

natural polymer 8-12% (by weight), and

organic polymer 8-12% (by weight).

### EMBODIMENT EXAMPLES

| Composition | Embodiment 1 | Embodiment 2 | Embodiment 3 |
|---|---|---|---|
| Starch | 78% | 82% | 80% |
| Natural polymer | 10% | 8% | 10% |
| Organic polymer | 12% | 10% | 10% |

The natural polymer may be pine resin. The organic polymer may be PET polyethylene terephthalate, PC polycarbonate, or the like.

The method of making zippers based on the foregoing materials includes the following steps:

1. selecting zipper materials (starch, natural polymer and organic polymer) according to selected weight proportions;

2. heating and blending the materials until viscous; and

3. forming zippers with zipper teeth and a linking zipper tape by an injection molding process and encasing paper fibers therein.

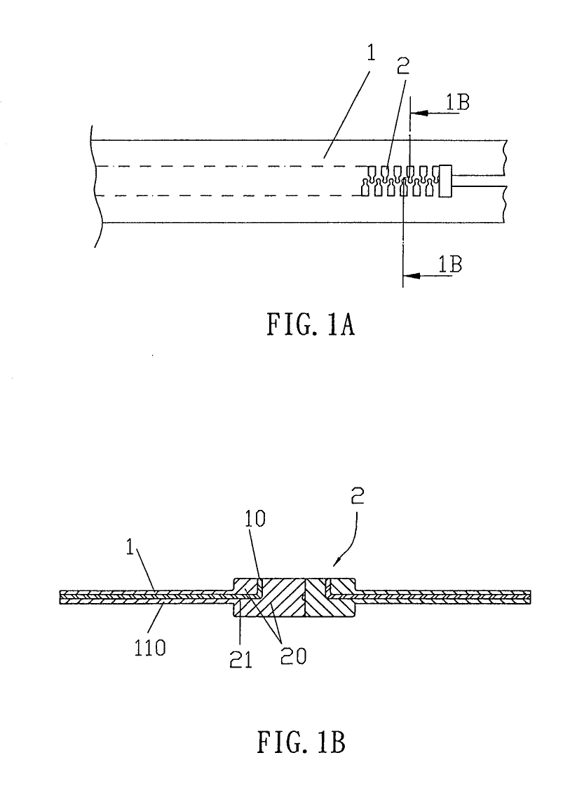

Referring to FIGS. 1A and 1B, the zipper made according to the materials and the method set forth above includes zipper teeth 2 which have a inner side formed an upper and lower protruding portion 20. The upper and lower protruding portion 20 has a first flute 20 formed in the center which is extended outwards to connect to a second flute 110 located in the center of the zipper tape 1. The first flute 20 and the second flute 110 encase a layer of paper fibers 10 to increase the strength of the zipper.

In summary, because the zipper of the invention is made from starch, natural polymer and organic polymer by injection with a linking zipper tape, there is no need to make zipper teeth separately from plastics or metal. Thus assembly of the zipper teeth and the zipper tape may be omitted. In addition, the zipper of the invention can be reclaimed and recycled, thus can enhance environmental protection and conservation.

What is claimed is:

1. A zipper making material, comprising:
starch 78-82% by weight,
natural polymer 8-12% by weight, and
organic polymer 8-12% by weight.

2. The zipper making material of claim 1, wherein the natural polymer is pine polymer.

3. The zipper making material of claim 1, wherein the organic polymer is selectively PET polyethylene terephthalate or PC polycarbonate.

4. The method of making zippers of claim 1, wherein the comprising steps are:
(1) selecting zipper materials according to selected weight proportions, including starch 78-82%, natural polymer 8-12% and organic polymer 8-12%;
(2) heating and blending the zipper materials until viscous; and
(3) forming zippers with zipper teeth and a linking zipper tape by an integrated injection molding process and encasing paper fibers therein.

5. The method of making zippers of claim 4, wherein the zipper comprising:
an upper and lower protruding portion located on an inner side of the zipper having a first flute located in the center thereof, the first flute being extended outwards to connect a second flute;
a zipper tape connecting to an the upper and lower protruding portion on one side opposite to the inner side and having the second flute located in the center thereof; and
a layer of paper fibers encased in the first flute and the second flute;
wherein the zipper is made from zipper materials according to selected weight proportions that include starch 78-82%, natural polymer 8-12% and organic polymer 8-12%, the zipper materials being heated and blended until viscous, and formed zipper teeth and the zipper tape linked to the zipper teeth by an injection molding process and encasing the paper fibers therein.
